(19) United States
(12) Patent Application Publication
(10) Pub. No.: US 2003/0072848 A1
(43) Pub. Date: Apr. 17, 2003

(54) Coated biscuit product

(76) Inventors: Alexis Mikael Paul Lecat, Forel-Lavauz (GB); Lucinda Joy Lambert Myers, Sao Paulo (BR)

Correspondence Address: WINSTON & STRAWN, PATENT DEPARTMENT, 1400 L STREET, N.W., WASHINGTON, DC, 20005-3502, US

(21) Appl. No.: 10/246,734

(22) Filed: Sep. 19, 2002

Related U.S. Application Data
(63) Continuation of application No. PCT/EP01/02206, filed on Feb. 27, 2001.

(30) Foreign Application Priority Data
Mar. 24, 2000 (GB) 0007249.6
Jul. 7, 2000 (GB) 0016840.1

(51) Int. Cl. A23G 3/00

(52) U.S. Cl. 426/94

(57) ABSTRACT

Processes for applying a barrier coating to a biscuit that is to be coated with a component having a hiugher moisture content. The barrier coating is a mixture of a high-melting fat and icing sugar and is applied uniformly to the biscuit by liquefying this coating and then applying it by rotating the biscuit during panning or brushing. The resultant coated biscuit products also form part of this invention.

### CROSS-REFERENCE TO RELATED APPLICATIONS

This application is a continuation of the U.S. national phase designation of International Application PCT/EP01/02206 filed Feb. 27, 2001, the content of which is expressly incorporated herein by reference thereto.

### FIELD OF THE INVENTION

The present invention relates to a method of preparing a coated biscuit more particularly a biscuit coated with a higher moisture component, such as caramel, jam, nougat, marshmallow, fondant, etc., and having a barrier coating between the biscuit and the higher moisture component.

### BACKGROUND OF THE INVENTION

Biscuits normally contain from 1-5% moisture and are considered to be dry. When biscuits are to be coated with a higher moisture component, a barrier coating is applied between the biscuit and the higher moisture component. In conventional products, the barrier coating is usually chocolate. However, the shelf life of such coated biscuits is only about 16 weeks. Thus, improvements in these type products are needed.

### SUMMARY OF THE INVENTION

We have found that the moisture migration between a dry biscuit component and a high moisture component can be retarded when a specially formuated barrier coating is applied. This barrier coating is an icing sugar/high-melting fat mixture. Moreover, this coating can be applied substantially uniformly to biscuits using a technique involving tumbling or rotating of the biscuit component. This technique results in a biscuit center that is encapsulated with the barrier coating and which can be further coated with higher moisture components to form further products.

Accordingly, the present invention provides a process for preparing a coated biscuit product. The biscuit is first provided with a barrier coating by preparing a mixture of a high-melting fat and an icing sugar, melting the mixture and applying the melted mixture to the biscuit while the biscuit is tumbled or rotated to form a barrier coated biscuit center. Then, the coated biscuit center is contacted with a component having a higher moisture content than the biscuit to form a coated biscuit product having a barrier coating between a partial or full coating of the higher moisture content component. The barrier coating is present in the coated biscuit product to retard moisture migration from the higher moisture content component to the biscuit to thus retain the cripness of the biscuit during storage and prior to consumption.

The invention also relates to a coated biscuit product comprising a biscuit, a partial or full coating of a component having a higher moisture content than the biscuit, and a barrier coating present between the biscuit and the higher moisture content component. Again, the barrier coating is a mixture of a high-melting fat and icing sugar and is present to retard moisture migration from the higher moisture content component to the biscuit to thus retain the cripness of the biscuit during storage and prior to consumption.

### DETAILED DESCRIPTION OF THE PREFERRED EMBODIMENTS

The barrier coating may be applied to the biscuit in any one of a plurality of techniques, including by the use of panning equipment, or by rotating the biscuit between soft fibers or brushes.

Panning is a process well known to those skilled in the art and is described, for example, in chapter 15 of Industrial Chocolate Manufacture and Use, Third Edition, 1999, edited by S. T. Beckett, Blackwell Science, on pages 287-301. Basically, panning involves a rotating container, usually a pan or a drum, that contains the component to be coated. Here, the pan or drum contains the biscuits, and the coating material is then added in a form in which it can coat the outside of the biscuits as they tumble over one another while the container is rotating. All outer surfaces of the biscuits are coated as the rotating container builds up multiple layers or continuous phases. The process is conducted until the biscuits become centers having coating material on essentially all outer surfaces.

The process utilizing soft fibers or brushes enables a substantially even coating application onto the biscuits at controlled temperatures. The coating may be achieved using brushing/painting equipment such as the EMT biturbine which is based on rotating the products along two helicoidal turbines contacted with the soft fibers or brushes.

The present invention also provides a biscuit coated with a higher moisture component and having a barrier coating between the biscuit and the higher moisture component characterised in that the barrier coating is a mixture of a high-melting fat and icing sugar.

The biscuit to be coated may be any kind of biscuit or cookie, e.g., shortcake, rich tea, digestive, or bourbon having a moisture content of typically from 1-5% (Aw from 0.1 to 0.5).

The fat should preferably be a food acceptable one have a relatively high-melting point. The fat is conveniently a vegetable fat having a melting point of at least 45° C., for instance from 55° C. to 100° C. and preferably from 60° to 90° C. The fat is preferably hydrogenated. Examples of hydrogenated fats include commercially available fats such as Cessa 60 from Karlsham's, Akofine NF, Cotebar H from Loders-Crooklaan and Confao 12 from Aahrus Olie.

Hydrogenated fats may be prepared by processes that are well-known in the oils & fats industry using hydrogen under pressure to modify the molecular structure of unsaturated fats to obtain various advantages such as higher melting point, better mouthfeel etc. Information about vegetable fats can be obtained from the text by G. Talbot, Vegetable Fats, in Industrial Chocolate Manufacture and Use, 3rd Edition, 1999, edited by S. T. Beckett, on pp. 307-322.

The mixture of hydrogenated fat and icing sugar advantageously contains from 15 to 50% by weight and preferably from 25 to 35% by weight of the hydrogenated fat based on the weight of the mixture. This coating is described in an article by G. Talbot in Candy Industry 1991(156 [1], pp. 53-56) entitled Putting a Lid on Moisture Migration. This article states that the moisture barrier is only effective if the dry center has a uniform coating. The author suggests using enrobing or spraying and notes that brushing does not work. His suggestions are insufficinet as enrobers are expensive and complicated machines and skilled operators are required to obtain a uniform coating, particularly on the base of the biscuit. This type of device is known to give an uneven coating such as the ‘feet’ shown in The Science of Chocolate by S. T. Beckett, RSC 2000, in Chapter 4, FIG. 4.2. Spraying is also difficult as this is normally carried out from one direction leading to a non uniform coating. The current invention provides methods which obtain a uniform coating by rotating the dry biscuits. The inventive process can also be carried out on relatively simple standard equipment with semi-skilled operators, thus providing significant adnvantages over the teachings of Talbot.

The higher moisture component that is applied to the coated biscuit may be any confectionery material, including caramel, jam, nougat, marshmallow, fondant, etc. Any of these components can be used based on the desire or preference of the skiled artisan in making the prducts of this invention.

Caramel may contain as basic ingredients, sugar, glucose syrup, milk protein, fat, salt and from 5 to 15% water. The term caramel includes toffee and related formulations that are well known to those skilled in the art and are described, for example, in Sugar Confectionery Manufacture, Second Edition, 1995, edited by E. B. Jackson, Blackie Academic and Professional, in Chapter 8 on page 289. The water activity of the higher moisture component caramel is preferably from 0.3 to 0.7. For clarity, it should be understood that the term “caramel” excludes products made by the breakdown of carbohydrate by heat or heat and alkali treatment, which products are predominantly used in conventional products solely as coloring materials.

The jam which may be used is advantageously a confectioner's jam, advantageously one having a high fruit content for the best flavor. Generally, and this jam has a solids content of above 70%, preferably fron 75 to 78% and an Aw that preferably is from 0.3 to 0.7.

The coating with the higher moisture component may be continuous or discontinuous, as required by the construction of the final product. The fully or partially coated biscuit may, if desired, be finally coated with chocolate.

After application of the barrier coating, the biscuit is then contacted with the higher moisture component, e.g., by depositing the biscuit in warm caramel (between 35° C. and 80° C.). Because of the high melting point of the fat, it is possible to expose the coated biscuit to the warm caramel or other warm high moisture materials without losing the integrity of the barrier. Therefore, the biscuit in the final product will remain crisper for a longer time.

The shelf life at ambient temperature of biscuits traditionally coated with a chocolate barrier in contact with a higher moisture component is typically about 16 weeks. We have found that the same product which is instead coated with the high melting fat barrier according to the present invention will generally have a shelf life of up to double this period, e.g., as long as 32 weeks.

### EXAMPLES

The following Examples further illustrates the present invention. Parts and percentages are given by weight.

### Example 1

To a shortcake biscuit comprising wheat flour, vegetable fat, sugars and raising agents there is applied a barrier coating comprising 75% Cotebar H (a fractionated, hydrogenated vegetable fat) and 25% icing sugar using a panning technique as described above. In all cases when the samples were cut in half the barrier was observed to be uniform.. Afterwards, the biscuit is deposited in warm caramel in a chocolate mold. The caramel coated biscuit and barrier coating had a shelf life of 32 weeks at ambient temperature.

### Example 2

To a crunch biscuit comprising wheat flour, vegetable fat, syrup, sugars and raising agents, there is applied a barrier coating comprising 70% Cessa 60 (a hydrogenated vegetable fat) using an alternative panning such as EMT biturbine. This process involves rotating products along two helicoidal turbines with soft fibers enabling even application of the barrier coating at controlled temperatures. In all cases, when the coated biscuits were cut in half the barrier coating was observed to be uniform. Afterwards, the biscuit is deposited in warm jam in a chocolate mold. The crunchiness of the biscuit is significantly improved over its shelflife.

What is claimed is:

1. A process for preparing a coated biscuit product which comprises:
providing the biscuit with a barrier coating by preparing a mixture of a high-melting fat and an icing sugar, melting the mixture and applying the melted mixture to the biscuit while the biscuit is tumbled or rotated to form a barrier coated biscuit center; and
contacting the biscuit center with a component having a higher moisture content than the biscuit to form a coated biscuit product having a barrier coating between a partial or full coating of the higher moisture content component, wherein the barrier coating is present to retard moisture migration from the higher moisture content component to the biscuit to thus retain the cripness of the biscuit during storage and prior to consumption.

2. The process according to claim 1 wherein the barrier coating is applied to the biscuit by using panning equipment.

3. The process according to claim 1 wherein the barrier coating is applied to the biscuit while the biscuit is rotated between soft fibers or brushes that contain barrier coating material.

4. The process according to claim 1 wherein the biscuit to be coated has a moisture content of from 1 to 5% by weight, the higher moisture content component has a water activity of 0.3 to 0.7, and the biscuit is tumbled or rotated until a uniform coating of barrier coating material is applied.

5. The process according to claim 1 wherein the high-melting fat is a vegetable fat having a melting point of from 45° C. to 100° C.

6. The process according to claim 1 wherein the mixture of high-melting fat and icing sugar contains from 15 to 50% by weight of high-melting fat based on the weight of the mixture.

7. The process according to claim 1 wherein the high-melting fat is a hydrogenated fat.

8. The process according to claim 1 wherein the higher moisture component is a caramel, jam, nougat, marshmallow or fondant.

9. The process according to claim 1 wherein the higher moisture component is a caramel that contains as basic ingredients, sugar, glucose syrup, milk protein, fat, salt and from 5 to 15% water.

10. The process according to claim 1 wherein the coated biscuit is further coated with chocolate.

11. A coated biscuit product comprising a biscuit, a partial or full coating comprising a component having a higher moisture content than the biscuit, and a barrier coating present between the biscuit and the higher moisture content component, wherein the barrier coating is a mixture of a high-melting fat and icing sugar and is present to retard moisture migration from the higher moisture content component to the biscuit to thus retain the cripness of the biscuit during storage and prior to consumption.

12. The coated biscuit according to claim 11 wherein the biscuit has a moisture content of from 1 to 5% by weight and the higher moisture content component has a water activity of 0.3 to 0.7.

13. The coated biscuit according to claim 11 wherein the barrier coating is uniformly present around the outside of the biscuit as multiple layers or continuous phases.

14. The coated biscuit according to claim 11 wherein the high-melting fat is a vegetable fat having a melting point of from 45° C. to 100° C.

15. The coated biscuit according to claim 11 wherein the mixture of high-melting fat and icing sugar contains from 15 to 50% by weight of high-melting fat based on the weight of the mixture.

16. The coated biscuit according to claim 11 wherein the high-melting fat is a hydrogenated fat.

17. The coated biscuit according to claim 11 wherein the higher moisture component is a caramel, jam, nougat, marshmallow or fondant.

18. The coated biscuit according to claim 17 wherein the higher moisture content component is a caramel that contains, as basic ingredients, sugar, glucose syrup, milk protein, fat, salt and from 5 to 15% water.

19. The coated biscuit according to claim 11, which further has a coating of chocolate.

20. The coated biscuit according to claim 19, wherein the choclate coating is the outermost coating of the product.
